(19) United States
(12) Patent Application Publication
(10) Pub. No.: US 2015/0379634 A1
(43) Pub. Date: Dec. 31, 2015

(54) Tools for Supporting Investment Transactions

(71) Applicant: David F. Smith, Atlanta, GA (US)

(72) Inventor: David F. Smith, Atlanta, GA (US)

(21) Appl. No.: 14/641,286

(22) Filed: Mar. 6, 2015

Related U.S. Application Data
(60) Provisional application No. 61/949,039, filed on Mar. 6, 2014.

(51) Int. Cl. G06Q 40/04

(52) U.S. Cl. CPC G06Q 40/04

(57) ABSTRACT

The invention may be used to facilitate swapping bond A for another bond. Data obtained from a public source may be used to provide information about bonds, issuers, and investors. A user may request swap candidates for bond A. An actionable filter identifying characteristics of bond A may be provided to the user. For each characteristic of bond A, the filter includes a window for the user to input an acceptable variance in the same characteristic of a swap candidate. The user's input into the filter is used to find swap candidates. They may be displayed for the user. Additional information about the swap candidates may be provided to the user upon request. The display of the swap candidates and provision of the additional information facilitates the swapping of bond A for another bond by at least saving the user time and effort in determining swap candidates.

### CROSS-REFERENCE TO RELATED APPLICATION

The present application claims priority to and benefit of the prior filed co-pending and commonly owned provisional application, filed in the United States Patent and Trademark Office on Mar. 6, 2014, assigned Ser. No. 61/949,039, entitled Tools for Supporting Investment Transactions, and incorporated herein by reference.

### FIELD OF THE INVENTIONS

The invention relates to apparatuses and methods that may support or facilitate one or more investment transactions, including, but not limited to, bond swapping

### BACKGROUND

Investment transactions include bond swapping. It may be defined as selling a debt instrument and using the proceeds to buy another debt instrument. An investor may engage in bond swapping with an objective or objectives including that of improving his or her financial position. A bond swap may be advantageous to an investor by increasing the quality of his or her portfolio, diversifying his or her portfolio, reducing an investor's tax liability, benefitting from interest rate changes, and/or giving an investor a higher rate of return and/or increasing total return. Two common types of bond swapping strategies including the “pure yield pickup” swap and the “tax” swap.

Additional information about “bond swapping” may be found at (I) Investopedia, “Get Active In Your Bond Portfolio”, www.investopedia.com/articles/08/bonds/active-management-bond-portfolio.asp, Mar. 4, 2015, which is incorporated herein by reference.

General definitions of investment terms may be found in the book by David L. Scott, Words: An A to Z Guide to Investment Terms for Today's Investor, Third Edition, Published by Houghton Mifflin Company, Copyright 2003 by Houghton Mifflin Company, which is incorporated herein by reference.

General information on bond investments may be obtained from the book The Bond Book: Everything Investors Need to Know About Treasuries, Municipals, GNMAs, Corporates, Zeros, Bond Funds, Money Market Funds, and More by Annette Thau, Third Edition, Copyright 2011, 2001, 1992 Annette Thau, published by The McGraw-Hill Companies, which is incorporated herein by reference.

General information on the ideas and assumptions behind commonly used statistics on risk and return for individual bonds and on fixed income portfolios may be obtained from the book Bond Math: The Theory Behind the Formulas by Donald J. Smith, Copyright 2011 Donald J. Smith, published by John Wiley & Sons, Inc., which is incorporated herein by reference.

### SUMMARY

Stated generally, the invention relates to tools for supporting and facilitating investment transactions. Embodiments of the invention may be used in the investment world to increase the efficiency of corporate bond trading, and particularly, may be used to increase the likelihood of executing bond swaps. The invention may be embodied in an apparatus, device, method, or system. Embodiments of the invention may be used in other fields than the financial field.

An embodiment of the invention may obtain or be provided with financial information such as data on issuers, bonds, and/or investors, and particularly, investors such as insurance companies. For example, such information may be obtained directly or indirectly from the National Association of Insurance Commissioners, which may include securities data (such as Schedule D) of insurance companies, the Trade Reporting and Compliance Engine System, which may include real time information such as up-to-date trade size, price, and yield reporting on all public investment grade bonds, and the data or input received from a user or designed by a user.

Embodiments of the invention may use the data on issuers, bonds, and/or investors in order to transform the data to facilitate and support investment transactions. The transformed data may be provided to a user such as a bond trader. Particularly, some of the transformed data may be provided to a user in response to a request from the user for it. The user may interact with an embodiment of the invention to request and receive additional information related to the transformed data. The user may make use of this additional information in his or her financial transactions.

For example, an embodiment of the invention may be used to facilitate swapping bond A for another bond. As noted above, the embodiment obtains data about bonds, issuers, and investors from at least a publicly available source of such data. The user may request information about the bond A, and in response, the embodiment may display characteristics about bond A for the user. He or she may request swap candidates for the bond A. In response to the request for the swap candidates, the embodiment may display an actionable filter table for use the user. The filter table may include at least some of the characteristics about bond A. For each of the characteristics about bond A, the filter table may be made to include a window for input by the user for an acceptable variance in the same characteristic of a swap candidate. The user may input one or more acceptable variances in the respective windows of the filter table. When the user is finished entering the one or more acceptable variances, the user may activate the filter. The embodiment then may use the input from the user to find the swap candidates. The swap candidates may be displayed for the user. The display of the swap candidates by the embodiment of the invention facilitates the swapping of bond A for another bond by providing the user with swap candidates.

Other features and advantages of the inventions may be more clearly understood and appreciated from a review of the following detailed description and by reference to the appended drawings and claims.

### BRIEF DESCRIPTION OF THE DRAWINGS

FIG. 1 illustrates a very high level view of the environment or manner in which an embodiment of the invention may be implemented.

FIGS. 2-14 illustrate tables as may be presented by an exemplary embodiment of the invention on a user interface of a computer and/or otherwise

### DETAILED DESCRIPTION

The invention is described herein with reference to exemplary embodiments, alternative embodiments, and also with reference to the attached drawings. The invention, however, can be embodied in many different forms and carried out in a variety of ways, and should not be construed as limited to the embodiments set forth in this description and/or the drawings. The exemplary embodiments that are described and shown herein are only some of the ways to implement the inventions. Elements and/or actions of the inventions may be assembled, connected, configured, and/or taken in an order different in whole or in part from the descriptions herein.

Herein, in terms of nomenclature, the singular includes the plural, the masculine includes the feminine or neutral, a person includes a corporation (and the like), and an embodiment may be an apparatus, a device, a method, and/or a system, unless otherwise noted.

Generally stated, the invention facilitates and supports investment transactions. Embodiments of the invention may be used in the investment world to increase the efficiency of corporate bond trading, and particularly, may be used to increase the likelihood of executing bond swaps. The hypothesis underlying embodiments of the invention is that over a large number of investment grade bonds (market size of greater than $7 trillion) and a large number of holders (greater than 4000 insurance companies), which also buy and sell bonds daily, there ought to be at least one client for whom a proposed trade works. Besides bond trades, embodiments of the invention may be used with extension swaps (for example, from a 10 year to a year bond of the same name), cross credit (for example, trading IBM to Walmart), shortening maturities, take out, pay up, etc.

An additional benefit of the use of embodiments of the invention with respect to the holdings of insurance companies is that there is much macro data about insurance company investment holdings, and patterns of activity and risk. This abundance of data may appeal to insurance analysts and sales and trading desk managers. Thus, use of the invention by bond traders with respect to the holdings of insurance companies may make them more valued, consultative partners to their insurance clientele.

The invention, however, should not be limited to investment transactions and the investment world. Embodiments of the invention may be used and applied to other fields within business such as high yield, emerging markets, mortgages, and may be used and applied to fields besides business.

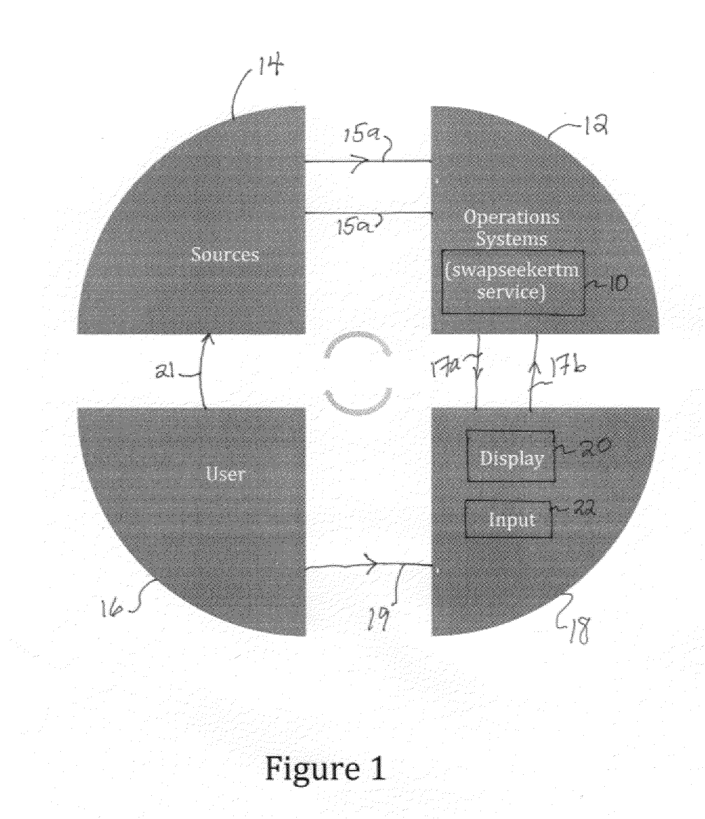

FIG. 1 illustrates a very high level view of the environment or manner in which an embodiment 10 of the invention may be implemented. This embodiment 10 is referred to herein as the SwapSeeker™ service 10 or “SwapSeeker.” It may be implemented as computer software or computer executable instructions stored on a computer readable medium as part of, in association with, and/or accessible by a computer, computer system and/or computing platform, which is referred to herein as the operations system 12. It may include one or more computing devices and the devices may be connected across a network (not illustrated). Information about computers may be obtained from the following: Apfel et al., U.S. Pat. No. 6,510,453 issued Jan. 21, 2003, and references cited therein, all of which are incorporated herein by reference.

The SwapSeeker embodiment 10 may cause the operations system 12 and other devices to carry out its instructions, rather than carry out the instructions itself. For purposes of brevity herein, reference may be made to the SwapSeeker 10 taking action when the action of the SwapSeeker may be to instruct the appropriate device to carry out the action.

The SwapSeeker embodiment 10 of the invention, as noted, facilitates and supports investment transactions. SwapSeeker may be used to increase the efficiency of corporate bond trading, and particularly, may be used to increase the likelihood of executing bond swaps. To accomplish its goals, SwapSeeker 10 may obtain or be provided with information such as data on issuers, bonds, and/or investors, and particularly, investors such as insurance companies. SwapSeeker 10 obtains this information or is provided it by sources 14 as indicated by arrows 15a, 15b between operations system 12 and source(s) 14 as shown in FIG. 1. The data on issuers, bonds, and/or investors may be obtained or provided in any appropriate manner. Moreover, the data on issuers, bonds, and/or investors may be obtained or provided once, more than once, periodically, continuously in real-time, updated, and/or refreshed in an automatic manner, in response to instructions from a user, and/or otherwise.

As is explained below, SwapSeeker 10 may use the data on issuers, bonds, and/or investors in order to transform the data to facilitate and support investment transactions. SwapSeeker 10 may cause the transformed data to be provided to a user 16. In the exemplary embodiment 10 shown in FIG. 1, SwapSeeker 10 causes the transformed data as shown by arrow 17a to be displayed to the user 16 on a personal computer 18 including a display 20. The term “personal computer” or “computer” may include any apparatus that may carry out substantially the same functions such as a laptop computer, tablet, mobile device, phlabet, cellular telephone, etc.

An embodiment of the invention may be implemented as a mobile application that may be used with a wireless device of a user. Such an implementation may allow a user to use the embodiment “round the clock” rather than just during Wall Street hours.

Advantageously, the user 16 may interact as indicated by arrow 19 with SwapSeeker 10 through use of the input 22 on his or her computer 20. The input 22 may be any appropriate apparatus such as a keyboard, or speaker for voice instructions. The input 22 may communicate with SwapSeeker 10 as indicated by arrow 17b.

FIG. 1 shows operations system 12 including SwapSeeker 10 as a separate device from but networked with the user's computer 18. An embodiment of the invention combines the operations system 12 including SwapSeeker 10 with the user's computer 18, and/or simply incorporates SwapSeeker 10 as part of the user's computer 18.

As noted previously, SwapSeeker 10 may use data on issuers, bonds, and/or investors to facilitate and support investment transactions in corporate bond trading, and particularly, in the execution of bond swaps. SwapSeeker 10 obtains and/or receives the data on issuers, bonds, and or investors from source(s) 14 as shown in FIG. 1.

Source(s) 14 may be any appropriate source. An example of a source is the National Association of Insurance Commissioners (“NAIC”), which may include securities data (such as Schedule D) of insurance companies. Instead of the NAIC directly or in addition to it, an embodiment of the invention may have as a source one or more of the third party entities that obtain NAIC information and make it available in its original form and/or in another form(s).

Another example of a source is the Trade Reporting and Compliance Engine (“TRACE”) System, which may include real time information such as up-to-date trade size, price, and yield reporting on all public investment grade bonds. Yet another example of a source may be data or input received from the user 16 or designated by the user 16 as indicated by arrow 21. Fewer/more and/or alternative sources may be used by embodiments of the invention.

Advantageously, SwapSeeker 10 may organize the data on the on issuers, bonds, and/or investors received and/or obtained from the Source(s) 14. The results of the organization(s) may be displayed in one or more tables (and/or in other manners) to the user 16.

As noted, the data may include data on issuers. An issuer is generally defined as a legal entity that develops, registers, and sells securities for the purpose of financings its operation. With respect to the SwapSeeker embodiment 10, the issuers' data may include the names of the issuers and respective characteristics of the respective securities of the issuers.

Advantageously, an embodiment of the invention such as SwapSeeker 10 may obtain and/or receive, organize, and/or display issuers' data. SwapSeeker 10 also may filter issuers and/or characteristics of issuers so that only the filtered issuers and their respective filtered characteristics may be made available for display and consideration. SwapSeeker 10 may include a selection of templates any one of which may be applied to the issuers and issuers' characteristics to obtain selected issuers with respectively selected characteristics. The user 16 may create his or her own templates for display of his or her selected issuers and selected issuers' characteristics.

As noted, SwapSeeker 10 may organize the data on issuers according to characteristics of the issuers. The issuers with their respective characteristics may be displayed to the user 16 such as in one or more tables. For example, a table may include columns and rows. The left most column of the table may display a list of issuers. The list of issuers may be organized alphabetically and/or otherwise. The top row may identify the characteristics associated with the issuers. The characteristics may be organized alphabetically and/or otherwise. For each issuer in the issuer's column, a row of issuers' characteristics may be displayed. Thus, a user may consult the table to find issuers' characteristic on one or more issuers included in the table.

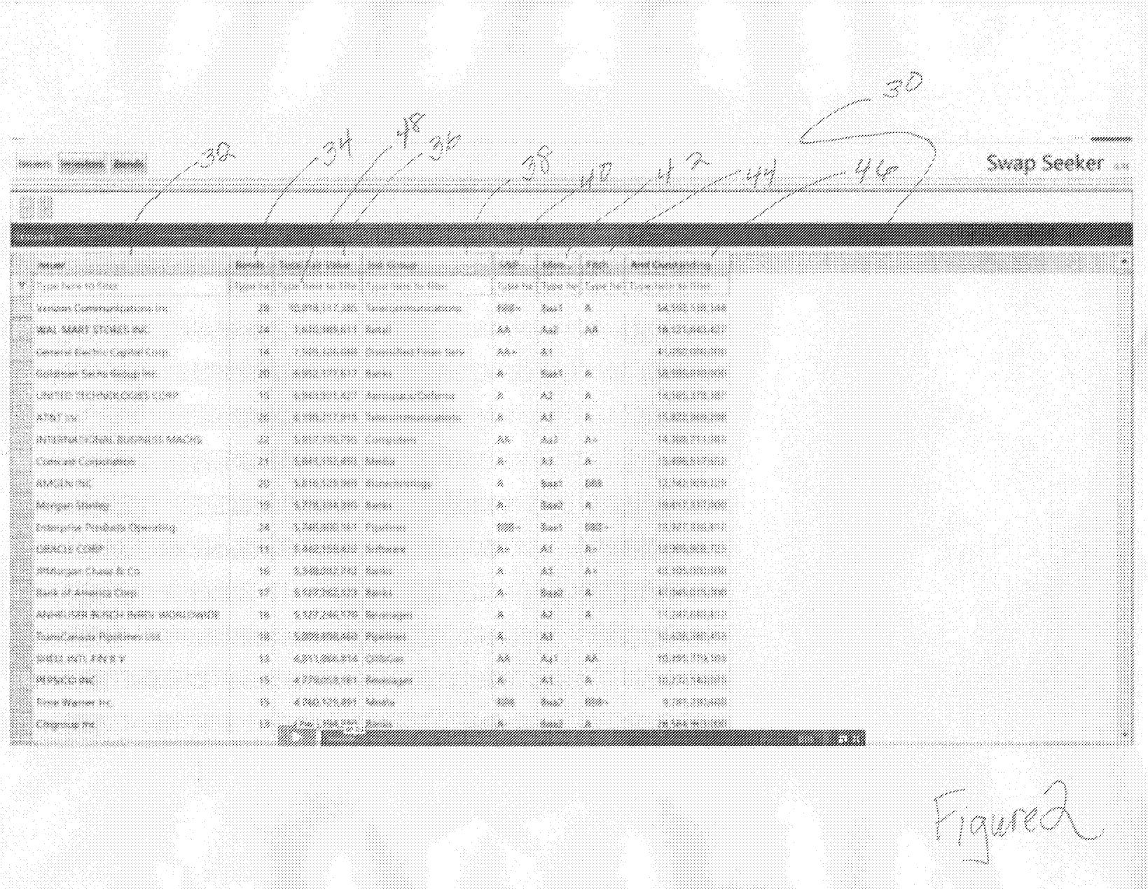

FIG. 2 illustrates part of an exemplary Table of issuers 30 to insurance companies such as may be presented to a user of SwapSeeker 10 in response to a request for such information. (Issuers to an entity(ies) other than and/or in addition to insurance companies may be displayed in other table(s) by SwapSeeker 10 based on a user's configuration.) Table 30 includes a left most column 32 identifying issuers by name. The next seven columns 34, 36, 38, 40, 42, 44 and 46 in the table 30 identify characteristics of the respective issuers in the column. In this example, the columns of characteristics are identified as follows: Bonds 34, Total Fair Value 36, Ind Group 38, S&P 40, Moo 42, Fitch 44, and Amt Outstanding 46.

In FIG. 2, there are seven characteristics in Table 30. Other tables of listings of issuers may have more or fewer or different characteristics. Advantageously, a user may select the characteristics for display in a table of issuers or there may be a default for the display of characteristics of an issuer. Another alternative may be that a user may select a template from a variety of templates for table of issuers. The characteristics in a table of issuers may depend on the data on issuers available from the source(s) 14.

In Table 30, below each column heading is a user selectable cell including the following terms: “Type here to filter.” Advantageously, a user may activate the selectable cell of a characteristic of an issuer to have information (also referred to as values) displayed in the column according to a value(s) of the characteristic. For example, in Table 30, the “Type here to filter” cell 48 below the column heading for the characteristic Total Fair Value 36 has been selected by the user or by default because the issuers in Table 30 are listed according to their respective Total Fair Value characteristics from largest to smallest. A toggle of the “Type here to filter” cell 48 may reverse the order from smallest to largest. The other characteristics in Table 30 also may be chosen to serve as the basis for the manner in which the information in Table 30 is displayed. Only characteristic of an issuer may be selected as the basis for the display of the information in Table 30. In other words, a user may not select both Total Fair Value 36 and S&P 40 as characteristics that serve as the bases for the display of the information in Table 30 because selecting one would change the display of information over the other.

The toggle or activation cell “Type here to filter” is available in other tables of the Swap Seeker embodiment 10 described herein. The other toggles relate to the characteristics and/or other information contained in their respective tables.

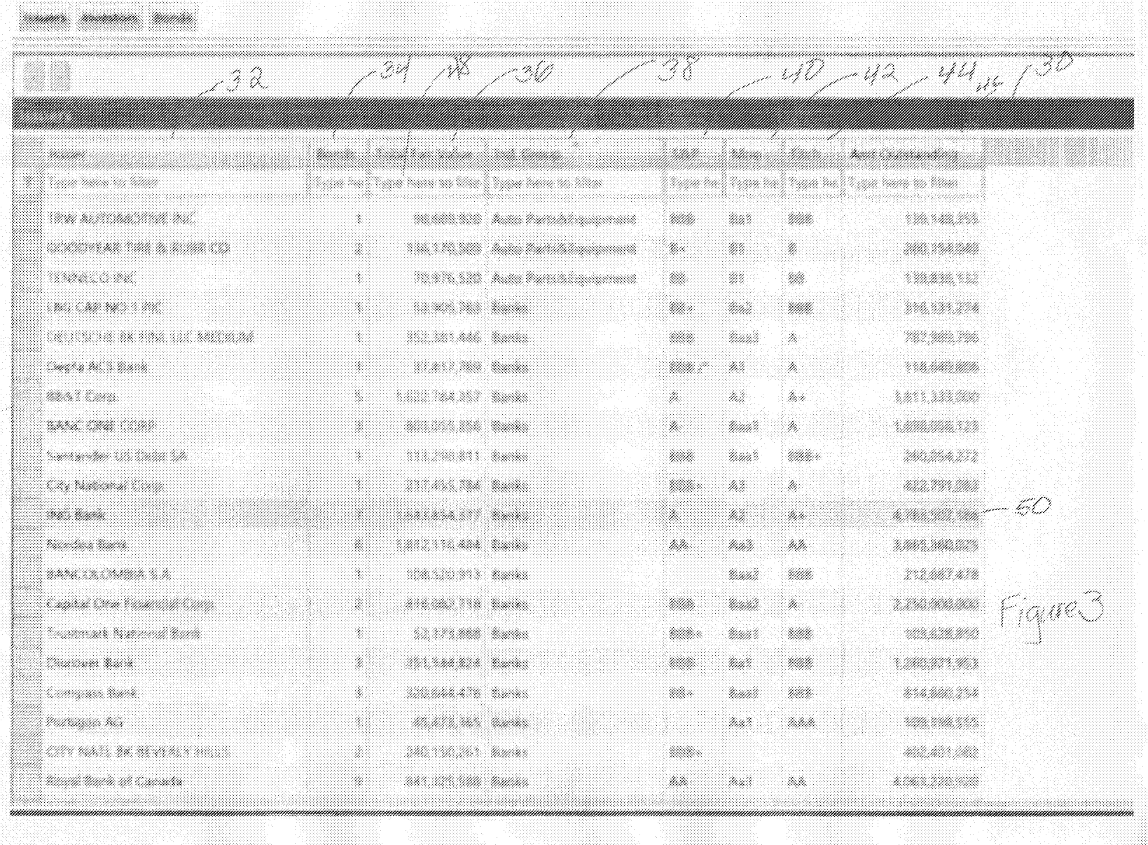

FIG. 3 is an illustration of a different part of Table 3 not shown in FIG. 2. Some of the issuers with their respective characteristics are shown listed in FIG. 3 according to the Ind. Group 38 characteristic. In the listing shown in FIG. 3, the issuers are group according to their respective industries, and then the industries are alphabetized within the column of Ind. Group 38.

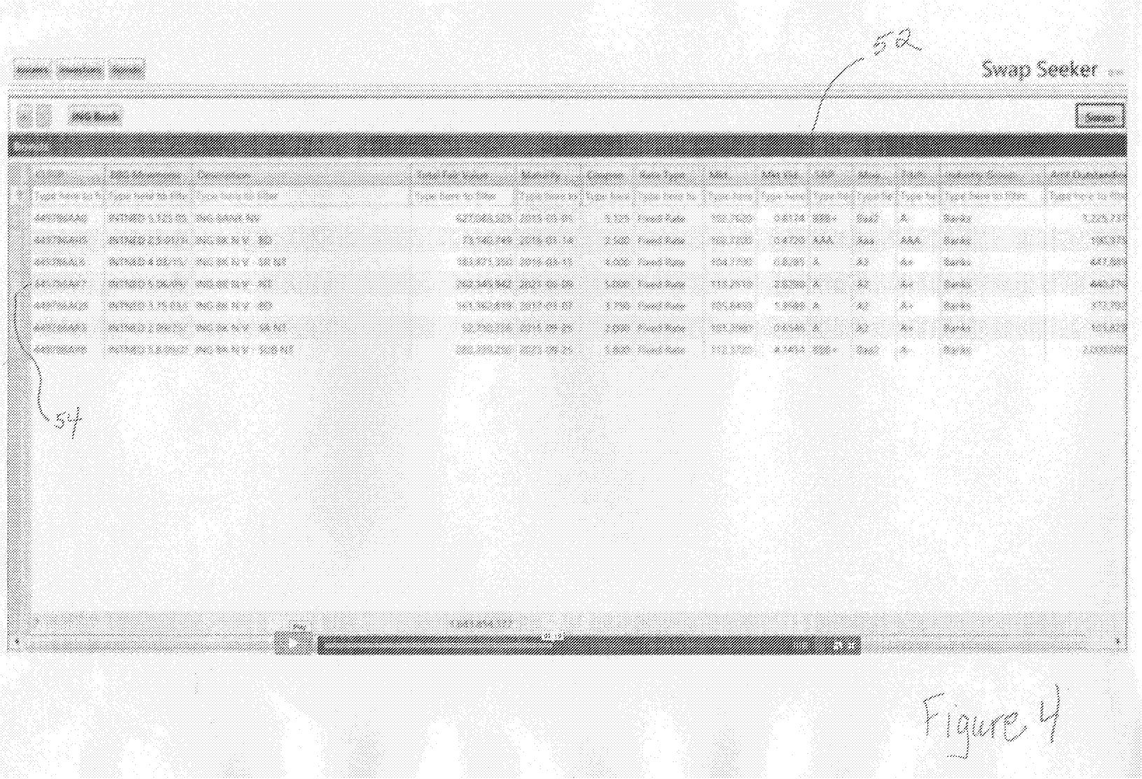

The reader's attention is drawn to the information in Table 30 regarding issuer ING Bank, which appears in the row marked 50. Advantageously, a user may activate that row 50 to obtain additional information about the issuer and its characteristics. The new information is shown in Table 52 of FIG. 4. This additional information may include a listing of the bonds of the issuer (ING Bank) ranked by maturity as shown by Table 52 together with other information.

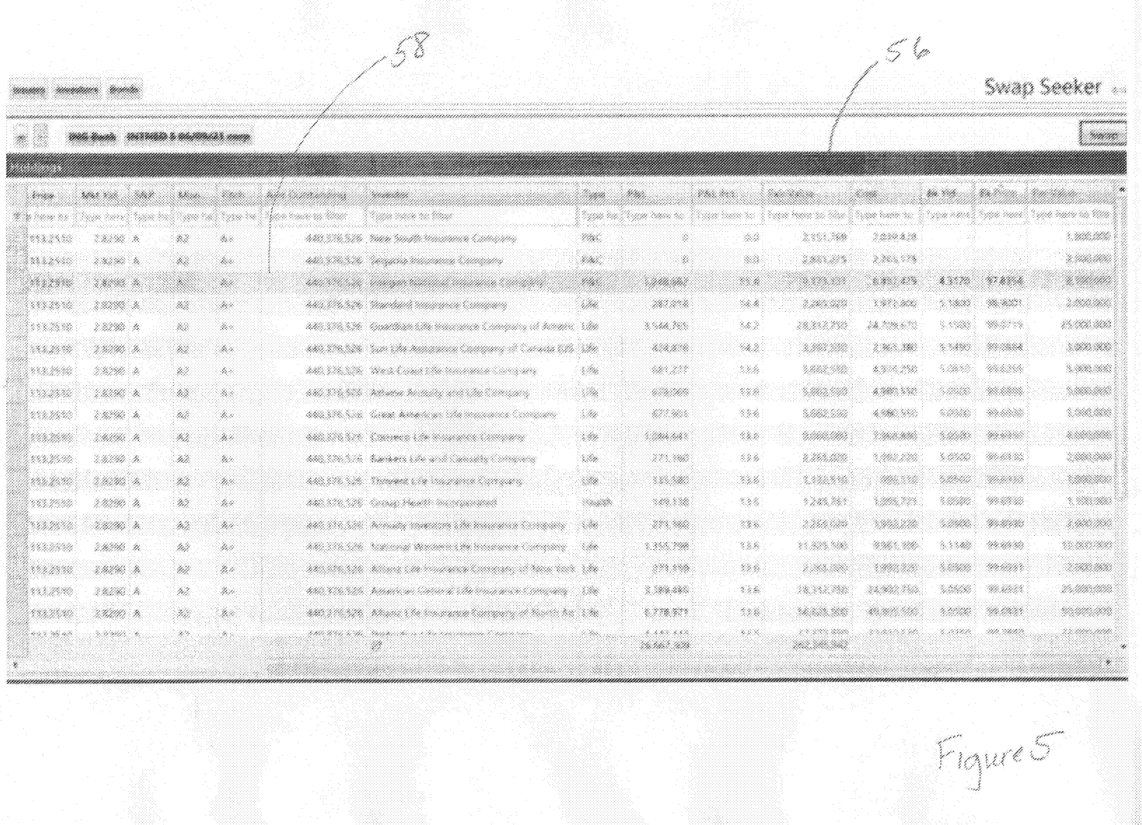

SwapSeeker 10 allows the user to dig deeper for information. For example, the user may activate one of the rows of Table 52 for more information. In this example, the user activates row 54 pertaining to one of the ING Bank bonds. The result of the activation of row 54 is shown in Table 56 illustrated in FIG. 5. Table 56 shows who owns the particular bond(s) selected as row 54 in Table 52 of FIG. 4. Besides who owns which bonds of ING Bank, Table 56 shows additional information including at what prices the bonds are owned. For example, row 58 of Table 58 shows that Integon National Insurance Company as the Investor owns the ING Bank bond(s) at 97 cents. Other information about the ING Bank bond selected as row 54 in Table 52 may be determined from the information displayed in Table 56.

SwapSeeker 10 also may receive or obtain, organize, and/or display data on investors. An investor also may be referred to as the lender, holder, or creditor. With respect to the SwapSeeker embodiment 10, the investors' data may include the names of the investors and respective characteristics of the respective securities of the investors. SwapSeeker 10 may be used to analyze an investor's holdings and to display them and their characteristics to the user.

Advantageously, an embodiment of the invention such as SwapSeeker 10 may obtain and/or receive, organize, and/or display investors' data. SwapSeeker 10 also may filter issuers and/or characteristics of investors' so that only the filtered investors' and their respective filtered characteristics may be made available for display and consideration. SwapSeeker 10 may include a selection of templates any one of which may be applied to the investors and investors' characteristics to obtain selected investors' with respectively selected characteristics. The user 16 may create his or her own templates for display of his or her selected investors and selected investors' characteristics.

As noted, SwapSeeker 10 may organize the data on investors according to characteristics of the investors. The investors' with their respective characteristics may be displayed to the user 16 such as in one or more tables. For example, a table may include columns and rows. A column of the table may display a list of investors. The list of investors' may be organized alphabetically and/or otherwise. The top row may identify the characteristics associated with the investors′. The characteristics may be organized alphabetically and/or otherwise. For each investor in the investors' column, a row of investors' characteristics may be displayed. Thus, a user may consult the table to find investors' characteristic on one or more issuers included in the table.

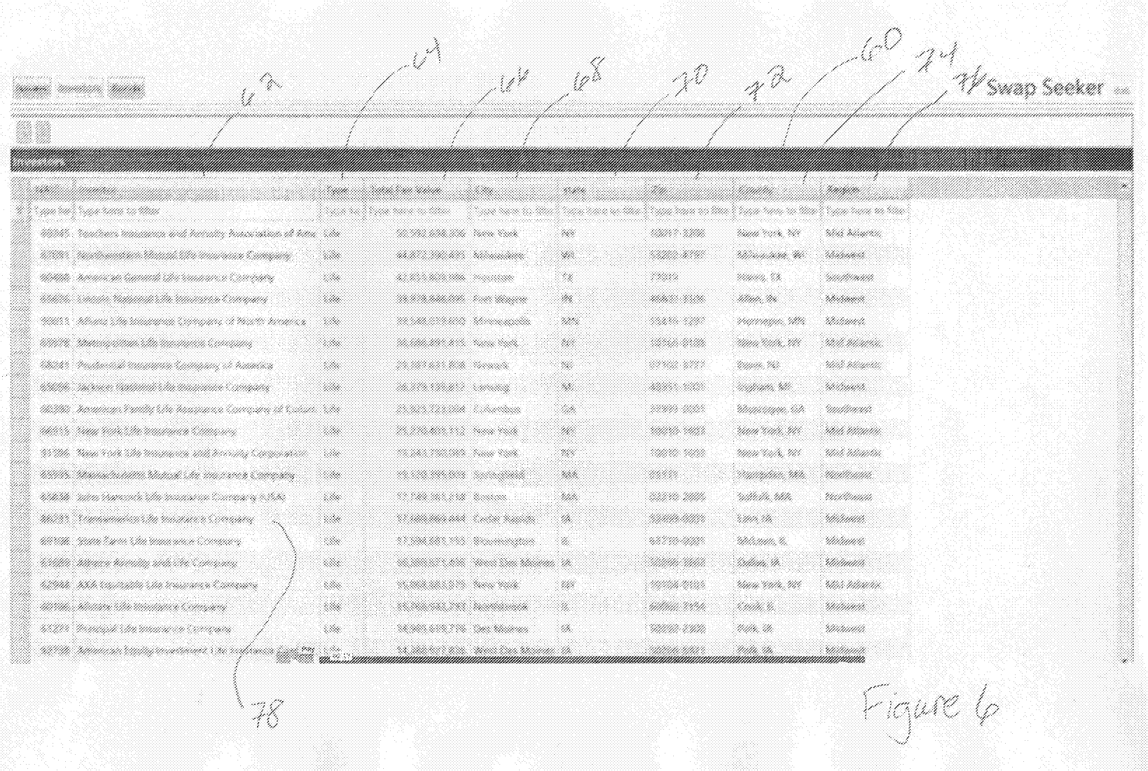

FIG. 6 illustrates part of an exemplary table of investors 60 such as may be presented to a user of SwapSeeker 10 in response to a request for such information. Table 60 includes a left column 62 identifying issuers by name. The next seven columns 64, 66, 68, 70, 72, 74 and 76 in the table 60 identify characteristics of the respective investors in the column 62. In this example, the columns of characteristics are identified as follows: Type 64, Total Fair Value 66, City 68, State 70, Zip 72, County 74, and Region 76.

In FIG. 6, here are seven characteristics in Table 60. Other tables of listings of investors may have more or fewer or different characteristics. Advantageously, a user may select the characteristics for display in a table of investors or there may be a default for the display of characteristics of investors. Another alternative may be that a user may select a template from a variety of templates for table of investors. The characteristics in a table of investors may depend on the data on investors available from the source(s) 14.

In Table 60, below each column heading is a user selectable cell including the following terms: “Type here to filter.” Advantageously, a user may activate the selectable cell of a characteristic of an investor to have information (also referred to as values) displayed in the column according to a value(s) of the characteristic. The selectable cells in Table 60 may function in a similar manner to the selectable cells described above in connection with Table 30.

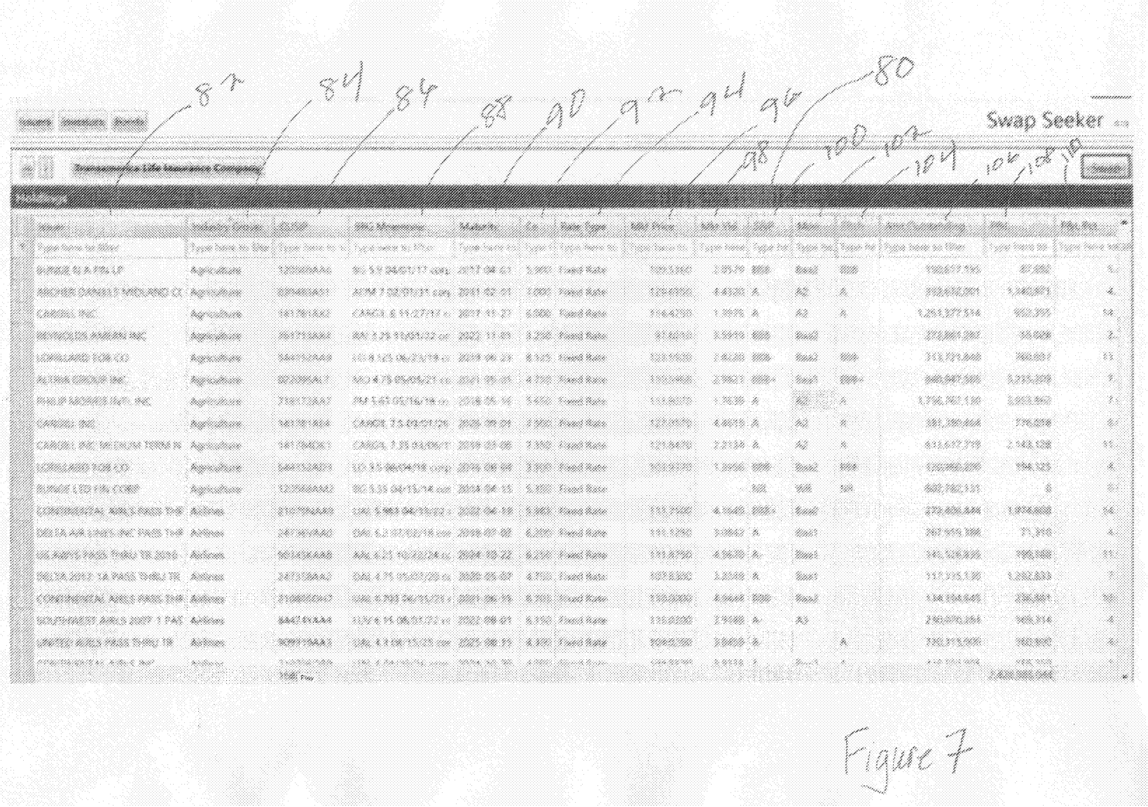

The reader's attention is drawn to the information in Table 60 of FIG. 6 regarding investor TransAmerica, which appears in the row marked 78. Advantageously, a user may activate that row 78 to obtain additional information about the investor and its characteristics. The new information is shown in Table 80 of FIG. 7. (Note—only part of Table 80 appears in FIG. 7). This additional information may include a listing of issuers 82 with their respective characteristics such as Industry Group 84, CUSIP 86, BBG Mnmonic 88, Maturity 90, Co 92, Rate Type 94, Mkt Price 96, Mkt Yld 98, S&P 100, Moo 102, Fitch 104, Amt Outstanding 106, P&L 108, P&L Pct 110, and/or others such as Fair Value, Cost, Bk Yd, Bk Price, and Par Value.

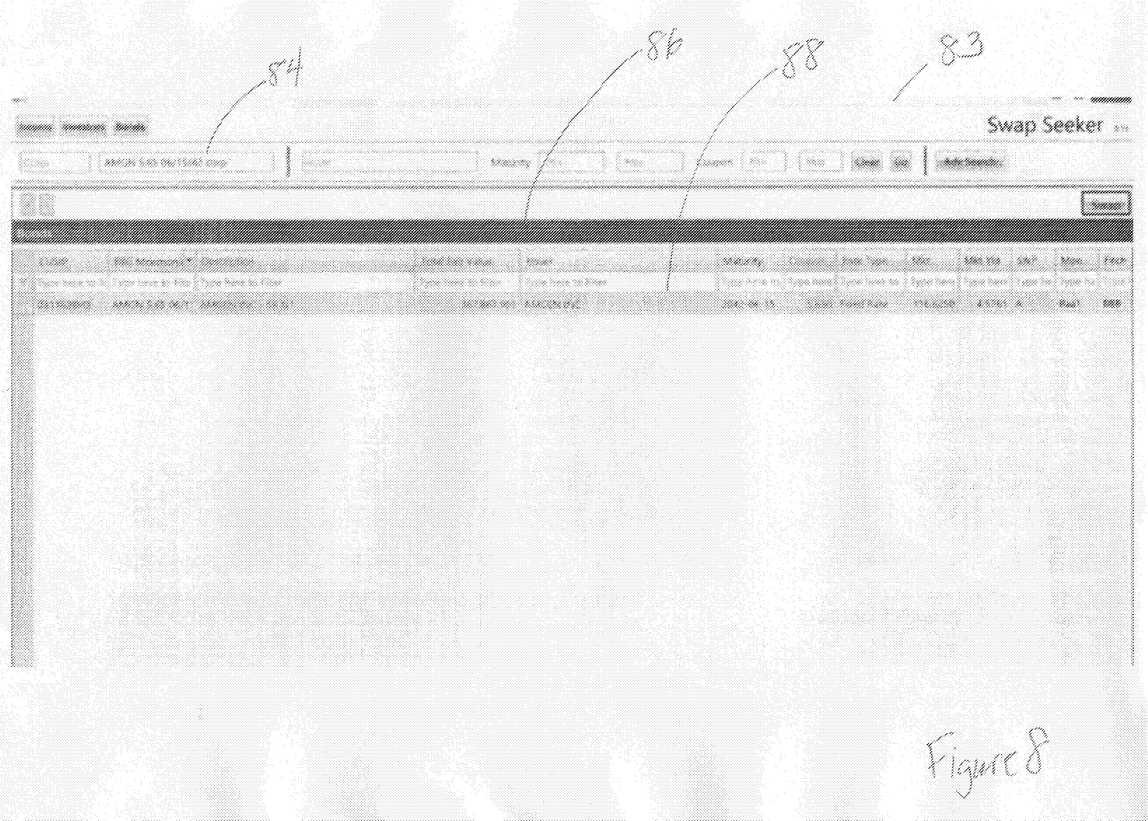

SwapSeeker 10 may be used to facilitate trades, and the source information from Schedule D at NAIC may be helpful. Assume you are a trader and you have been instructed to trade (sell) AMGN 5.65 06/15/42 (“AMGN”). SwapSeeker 10 may provide a user interface 83 (in table form and/or otherwise) for you to enter the information in a cell 84 as shown in FIG. 8. As a result of entering the appropriate information, data about AMGN is returned and displayed such as shown in row 88 of table 86 in FIG. 8. You may use this displayed information in seeking a swap for AMGN. One way of using this information about AMGN is to obtain more information by clicking on the row for AMGN 88 in Table 86.

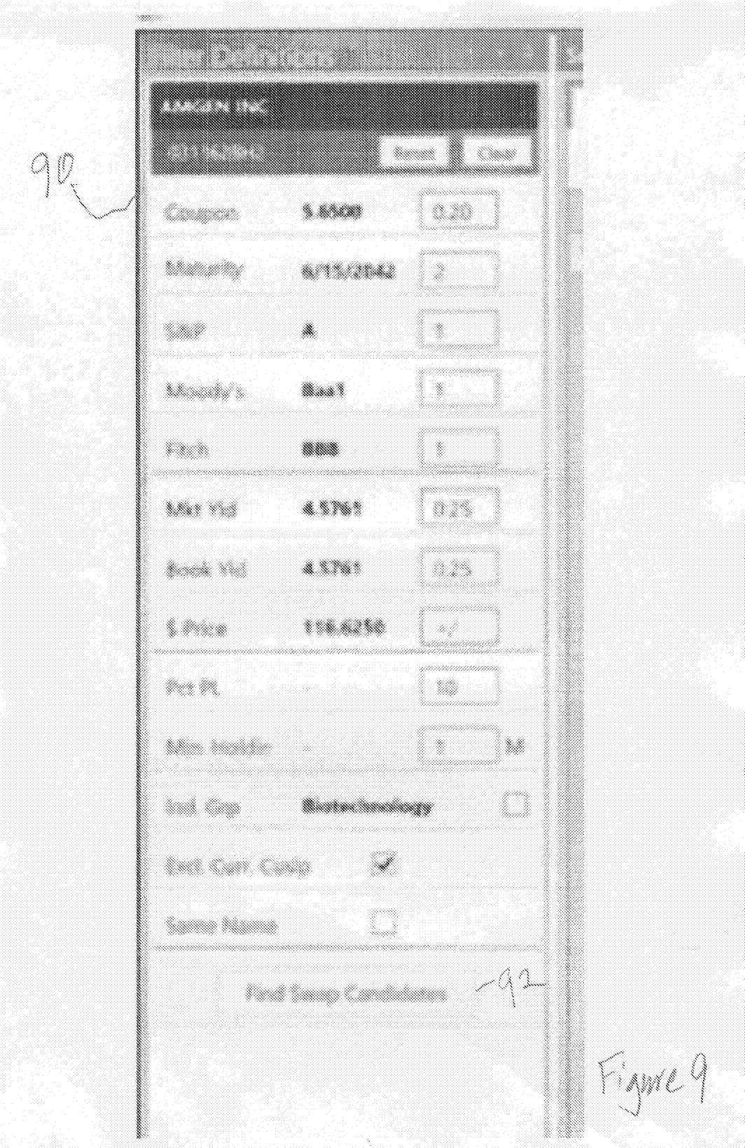

The additional information about AMGN 88 may appear in a user interface 90 such as shown in FIG. 9. In this example, the additional information includes characteristics or values for AMGN 88 such as Coupon, Maturity, S&P, Moody's, Fitch, Mkt Yld, Book Yld, $ Price, Pct. PL, Min. Holder, and Ind Grp. As noted, you as an investor are looking to swap AMGN 88. Interface 90 includes empty cells or windows in associated with each of the characteristics of AMGN 88. You may enter values in these windows to indicate acceptable values in a bond for which you are interested in swapping AMGN 88. The user may be able to enter his or her own selected values, or SwapSeeker 10 may provide options. In addition to the windows corresponding to bond characteristics, the interface 90 may include additional windows relating to a value or characteristic of a bond for which the investor is willing to swap AMGN 88. After entering information into one or more of the windows in interface 90, the trader may activate the “Find Swap Candidates” button 92.

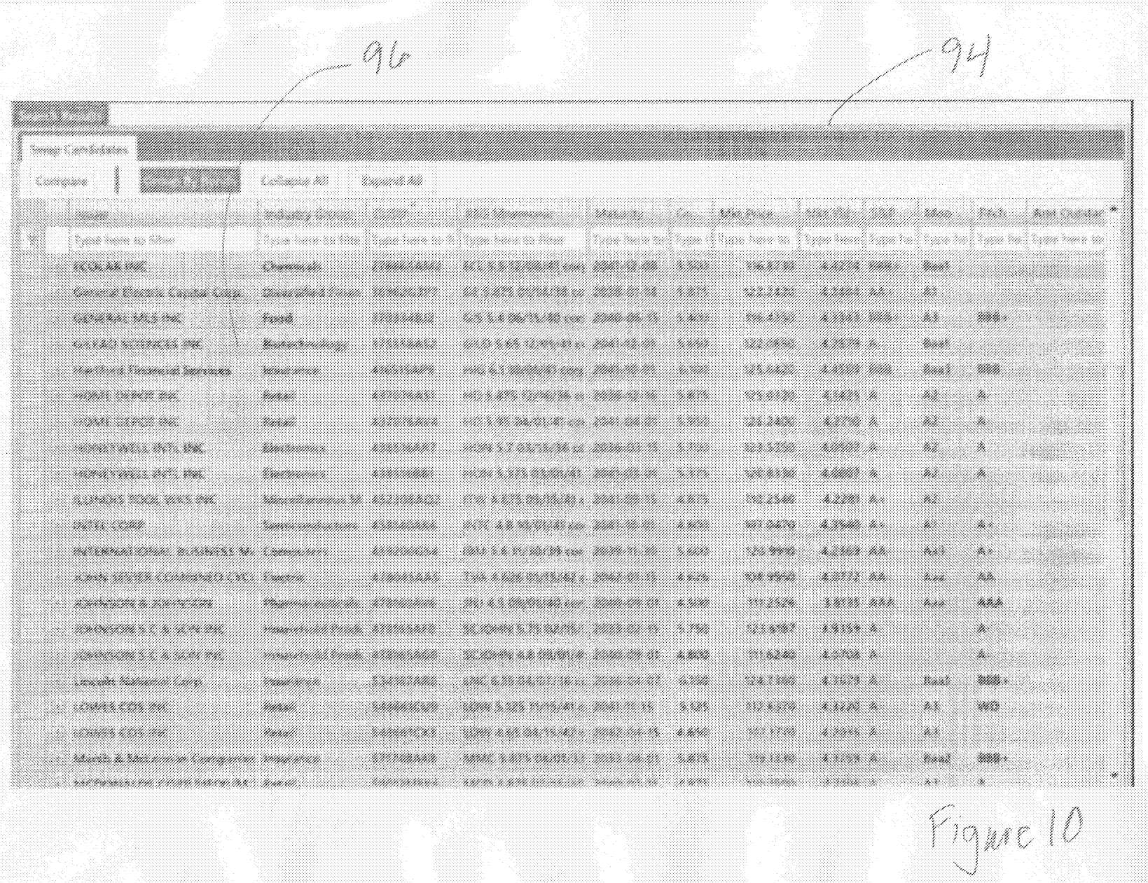

FIG. 10 shows part of a table 94 of potential swap candidates for AMGN returned by the SwapSeeker embodiment 10 in response to the information submitted in the user interface 90 shown in FIG. 9. The potential swap candidates are shown by issuer and associated characteristics or values. A trader may use this list of candidates to seek a trade for the AMGN.

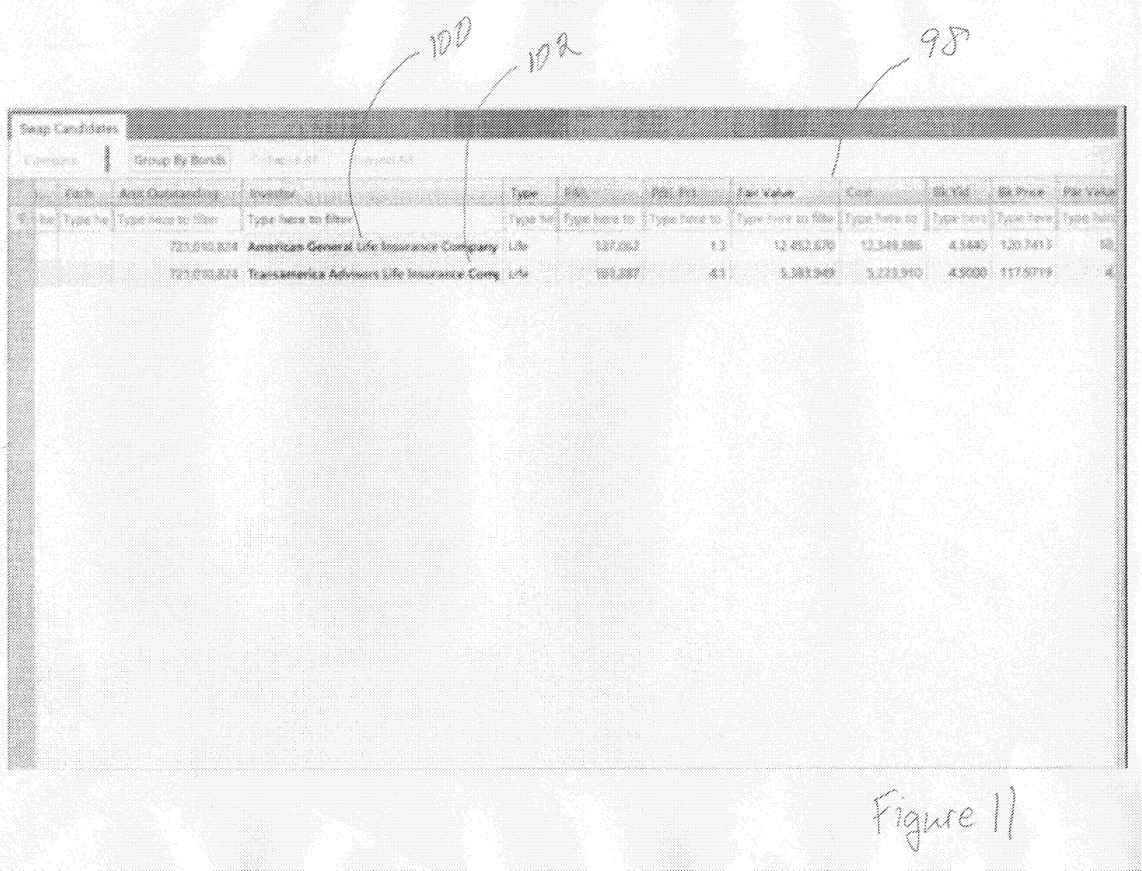

SwapSeeker 10 allows a trader to obtain additional information about the potential swap candidates shown in table 94 of FIG. 10. The trader may activate the issuer about which he or she seeks further information. For example, the trader may activate row 96 related to Gilead Sciences. As a result, SwapSeeker 10 provides more information about Gilead Sciences in table 98 shown in FIG. 11. In particular, Table 98 shows that two investors own the Gilead Sciences swap candidate. Information about the first investor, American General Life Insurance Company, and its ownership is shown in row 100 of Table 98. Information about the second investor, Transamerica, is shown in row 102 of Table 98. The trader may consider this information about the investors to consider whom to contact regarding a swap for AMGN.

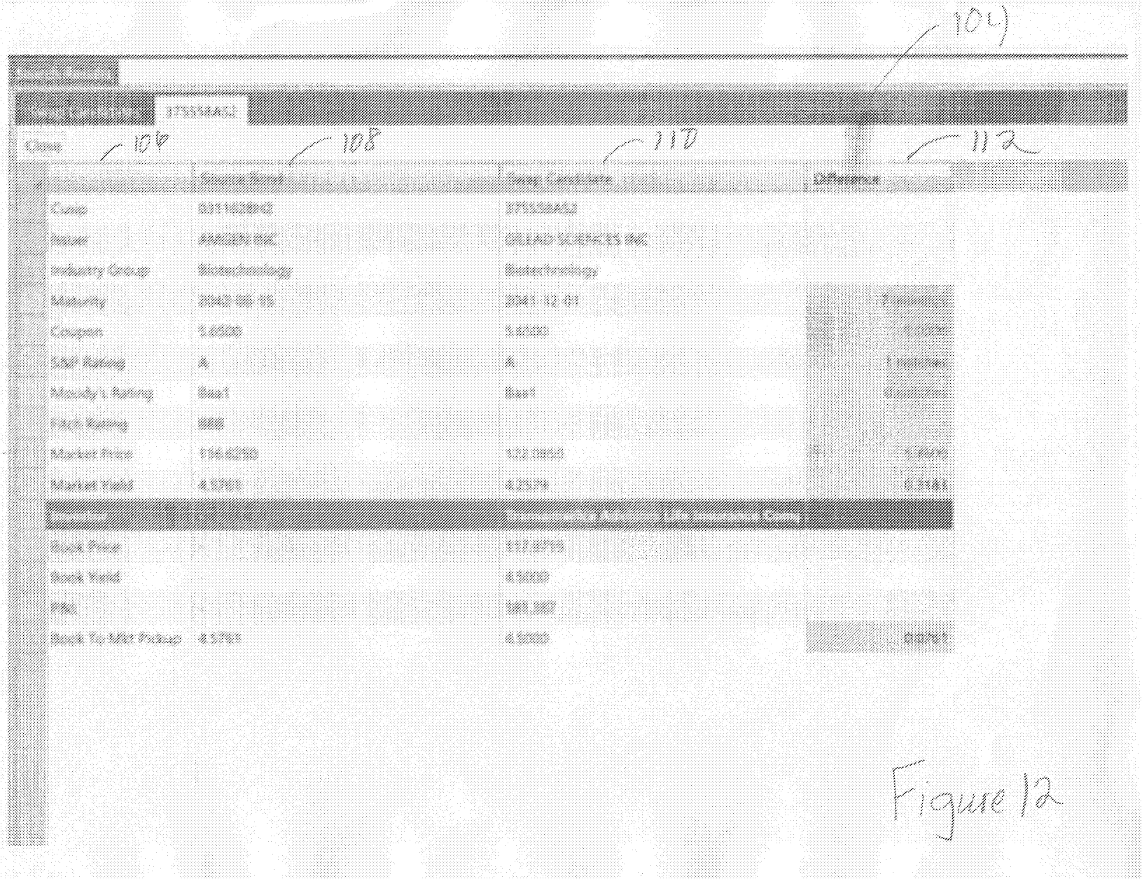

SwapSeeker 10 advantageously provides the trader with a display of comparison information between the bond to be swapped (AMGN in this example) and a swap candidate (Gilead owned by Transamerica in this example). To obtain the comparison display, the trader may activate the Transamerica row 102 of Table 98 in FIG. 11. An example of the resulting comparative display 104 is shown in FIG. 12. The display 104 is a table of columns and rows and includes a column of characteristics 106, a column for the Source Bond (AMGN) 108, the Swap Candidate 110, and Difference 112. For each characteristic in the list 106, a row with cells with information relating to the Source Bond, the Swap Candidate and the Difference are included.

Another advantageous use of the SwapSeeker 10 is that it may be used to streamline the liability management process with respect to bond trading and/or other financial transactions.

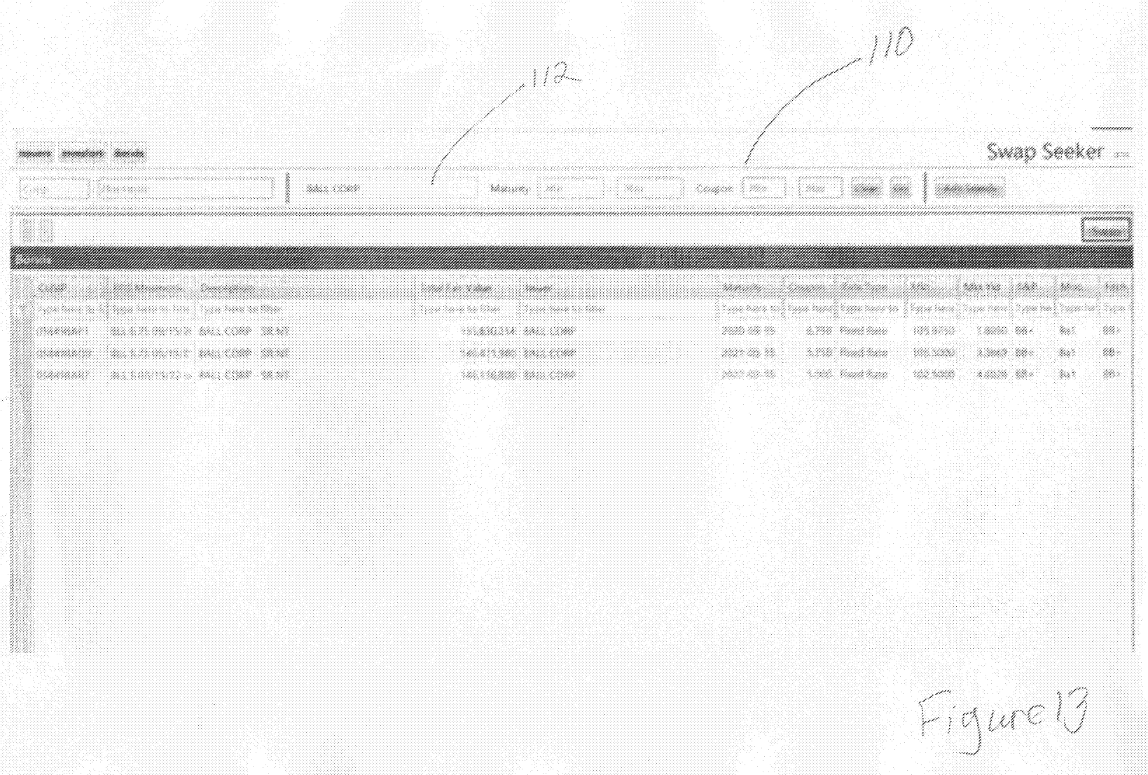

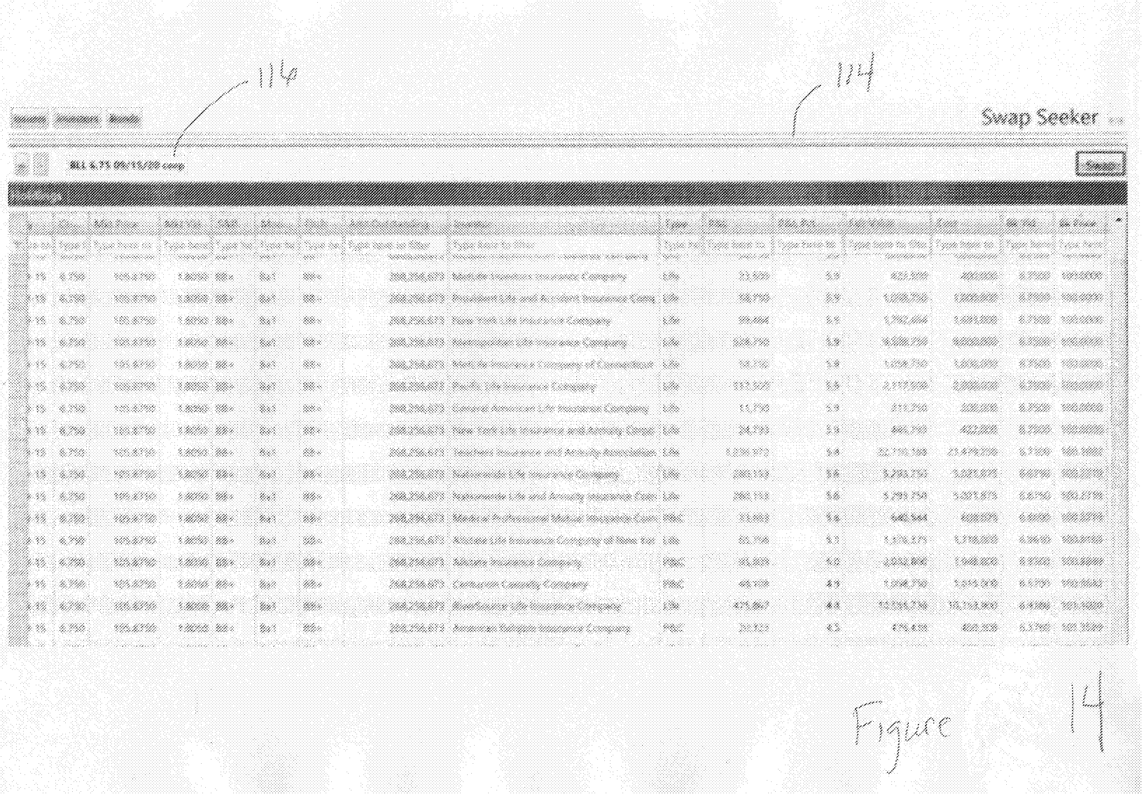

For example, assume a liability management officer is working on behalf of Ball Corp. The officer may use SwapSeeker 10 by inputting the name “Ball Corp” into a window 112 of a user to pull up information such as shown in Table 110 of FIG. 13. Table 110 includes three rows information on Ball Corp. financial matters. Assume the officer seeks additional information on the first matter in the first row listed in the Table 110. The officer may activate that row and obtain such additional information in the form of a Table 114 as shown in FIG. 14 (only part of Table 114 in shown in FIG. 14.)

Particularly, Table 114 of FIG. 14 identifies the Ball Corp financial matter in a window 116. With respect to that financial matter, Table 114 includes information such as the name of the investor, and other characteristics of the investors' ownership such as previously mentioned and as shown in Table 114.

Advantageously, SwapSeeker 10 allows a bond trader to input a bond A the trader wants to sell. SwapSeeker 10 may provide information about bond A to the bond trader in a form specified by the bond trader and/or by characteristics related to the bond A. The bond trader may use SwapSeeker 10 to determine candidates for swaps, and to obtain additional information about the candidates for swaps.

The bond trader may input a bond B that the bond trader believes is a good swap candidate. In return, SwapSeeker may provide information on who owns the swap candidate, how much of the swap candidate is owned by the owner, at what price and what yield (among other information as may be selected by the bond trader such as the gain(loss) from the swap, the yield pickup (ive), and duration extension shortening).

An alternative embodiment of SwapSeeker 10 may be implemented so as not to wait for a request from a user such a bond trader, but rather, be implemented to continually provide information on bond swaps, and/other matters, financial or not. For example, the alternate embodiment might download all of a dealer's inventories. Based on the inventories, the alternative embodiment may provide information on swaps that might work. The alternative embodiment may be given set parameters by traders or management and/or operate on default parameters. In other words, the alternative embodiment could be running at all times in the background of a user's world of financial transaction, returning trades that “work” in real time. The alternate embodiment could send the potential trades to the trader and/or directly to sales.

Yet another embodiment of the invention may operate with respect to a client's portfolio rather than a bond trader's inventory. This embodiment could load the client's portfolios, and look for swaps from dealer positions or runs.

An embodiment of the invention may be used by a client of a bond trader in place of the bond trader. The client may use the embodiment to see all their other competitors' and peers' bonds and costs at their fingertips, and potentially construct trade directly with each other. This may have a potential public policy effect of reducing transactions costs for the client.

Other public reporters of securities holdings could expand use of the invention in implementations related to the subject matter of these other securities holdings. For example, mutual funds state and local pension accounts, etc. all must report.

Other embodiments of the invention could be made to work with asset classes such as cmos (collaterized mortgage obligations), private label rmbs (residential mortgage backed securities) and cmbs (commercial mortgage backed securities).

### CONCLUSION

The exemplary embodiments of the invention were chosen and described above in order to explain the principles of the invention and its practical applications so as to enable others skilled in the art to utilize the inventions including various embodiments and various modifications as are suited to the particular uses contemplated. The examples provided herein are not intended as limitations of the present invention. For instance, many examples herein refer to use of the embodiments with a wireless device. Uses with other types of apparatus, devices, items, methods, and/or systems may be appropriate. Other embodiments will suggest themselves to those skilled in the art. Therefore, the scope of the present invention is to be limited only by the claims below.

1. A method for facilitating swapping bond A for another bond, comprising:
obtaining data about bonds, issuers, and investors from at least a publicly available source of such data;
receiving a request from a user for information about the bond A;
displaying characteristics about the bond A for the user with the characteristics being culled from the obtained data about bonds, issuers, and investors;
receiving a request from the user for swap candidates for the bond A;
in response to the request for the swap candidates, displaying an actionable filter table for the user;
causing the filter table to include at least some of the characteristics about the bond A;
for each of the characteristics about the bond A, causing the filter table to include a window for input by the user for acceptable variance in the same characteristic of a swap candidate;
accepting the window input from the user;
receiving an activation of the filter table with the window input from the user;
in response to activation of the filter table by the user, using the window input from the user to find the swap candidates from the obtained data about bonds, issuers, and investors; and
displaying the swap candidates for the user,
whereby the display of the swap candidates to the user facilitates the swapping of bond A for another bond.
